(19) United States
(12) Patent Application Publication
(10) Pub. No.: US 2025/0010192 A1
(43) Pub. Date: Jan. 9, 2025

(54) Method For Outputting Sound Effects During Video Game Gameplay

(71) Applicant: Sony Interactive Entertainment Europe Limited, London (GB)

(72) Inventors: Nick Ward-Foxton, London (GB); Andrew William Walker, London (GB); Calum Armstrong, London (GB); Juuso Tolonen, London (GB)

(73) Assignee: Sony Interactive Entertainment Europe Limited, London (GB)

(21) Appl. No.: 18/763,144

(22) Filed: Jul. 3, 2024

(30) Foreign Application Priority Data
Jul. 6, 2023 (GB) 2310388.0

(51) Int. Cl. A63F 13/54; G11B 27/031

(52) U.S. Cl. CPC A63F 13/54; G11B 27/031

(57) ABSTRACT

A computer-implemented method for outputting a sound effect during video game gameplay is disclosed. The method comprises the steps of: determining a sound effect to be output; retrieving a source sound and a sound-editing operator from a memory device, wherein the sound-editing operator comprises an edit that, when applied to the source sound, generates the sound effect to be output; applying the sound-editing operator to the source sound to generate the sound effect to be output; and outputting the sound effect.

### CROSS-REFERENCE TO RELATED APPLICATION

The present application claims priority from United Kingdom Patent Application No. GB2310388.0 filed Jul. 6, 2023, the disclosure of which is hereby incorporated herein by reference.

### FIELD OF THE INVENTION

Disclosed herein is a method for outputting a sound effect during video game gameplay. Also disclosed herein is a method generating sound effects to be output during video game gameplay.

### BACKGROUND

In video game systems, audio files comprising sound effects are typically stored in a memory device of a gaming console running the video game, for example. When the video game is run by the gaming console the video game requires certain sound effects to be output, in response to certain events in the video game. The audio files corresponding to such events must be called and output by the console. This is a computationally expensive process. Audio files associated with multiple different games are often stored in a memory device of a gaming console belonging to a video game player, which uses up a significant capacity of the memory device. Furthermore, in modern video game development, the generation of new sound effects by video game sound developers takes a considerable amount of time and is also a computationally expensive process.

It is an object of the invention to attempt to address some these issues.

### SUMMARY OF INVENTION

In an aspect of the present invention there is provided a method for outputting a sound effect during video game gameplay, the method comprising: determining a sound effect to be output; retrieving a source sound and a sound-editing operator from a memory, wherein the sound-editing operator comprises edit instructions that, when applied to the source sound, generates the sound effect to be output; applying the sound-editing operator to the source sound to generate the sound effect to be output; and outputting the sound effect.

In this way, only the source sound and the sound-editing operator required to produce the desired sound effect have to be stored in a memory device of a video game system. Therefore, it is possible to avoid having to store many variants of similar sound effects which consume limited memory resources of a video game system. Data associated with sound-editing operators uses fewer resources than that of the source effects themselves.

For example, by taking a source sound, for example an existing sound effect, and by applying a sound-editing operator, a desired sound effect can be generated and output from the video game system, without saving an audio file encoding the desired sound effect itself. During video game gameplay, only the source sound needs to be stored along with the sound-editing operator, as opposed to storing the both the source sound and the desired sound effect. In some examples, just the source sound and a plurality of sound-editing operators could be stored to generate a plurality of required sound effects using a single saved source sound.

In embodiments of the invention, the step of retrieving a source sound comprises retrieving an audio file corresponding to the source sound. The sound editing-operator edits data in the audio file corresponding to the source sound to transform the source sound into a new audio file corresponding to the sound effect. The new audio file associated with the sound effect need not be stored in a memory device of the video game system. The sound editing operating may comprise instructions to edit one or more properties of the waveform encoded in the audio file corresponding to the source sound.

Preferably, the sound effect to be output is determined in response to a gameplay event in the video game. In this way, specific sound effects required at different stages of the gameplay can be generated and output by the video game system on an ad hoc basis.

Preferably, the sound-editing operator comprises instructions to perform one or more of: an edit of an amplitude or amplitude range of the source sound; an edit of a frequency or frequency range of the source sound; an edit of temporal characteristics of the source sound; or an edit of phase characteristics of the source sound. In this way, properties of the audio file associated with the source sound can be altered significantly to generate new audio files corresponding to sound effects that are different in nature to the source sound.

Preferably, the sound editing operator comprises a variable edit parameter for editing a parameter of the source sound by a variable magnitude within a predetermined range, wherein the variable magnitude is selected at runtime during gameplay. In this way, the magnitude of the source sound can be edited.

Preferably, the method comprises: determining a plurality of sound effects to be output; retrieving a source sound and a plurality sound-editing operators from a memory, each sound-editing operator comprising edit instructions that, when applied to the source sound, generates a different sound effect to be output; applying each sound-editing operator to the source sound to generate the sound effect to be output; and outputting the sound effect. In this way, a single source sound may be used to produce multiple different sound effects, thereby saving memory as only the source sound and the sound-editing operators need to be stored.

Preferably, the sound-editing operator is determined by: applying a plurality of candidate sound-editing operators to the source sound to generate a plurality of candidate sounds from the source sound; comparing each of the candidate sounds with known sounds in a library of known sounds to determine the suitability of each of the candidate sounds for use in the video game; and based on the comparison, storing the source sound and the associated sound-editing operator associated with the selected candidate sound in the memory for use in generating sound effects to be output during video game gameplay. This process may be carried out prior to gameplay being initiated, for example at the development stage, with the sound effects then generated using the determined sound-editing operators during gameplay.

Alternatively, the sound-editing operator is determined by: applying a plurality of candidate sound-editing operators to the source sound to generate a plurality of candidate sounds from the source sound; outputting the candidate sounds; receiving a user input selecting a candidate sound; and storing the source sound and the sound-editing operator associated with the selected candidate sound in the memory for use in generating sound effects to be output during video game gameplay.

In this way, when developing the video game, sound effects suitable for use in the video game can be produced without using valuable memory resources as only the relevant sound-editing operators are stored. In embodiments of the invention, audio files associated with the candidate sounds are compared with audio files associated with known sounds to determine the suitability of the candidate sounds for use in the video game.

In embodiments of the invention, storing the source sound and the associated sound-editing operator in the memory may comprise storing the source sound and a ranged sound-editing operator. For example, such ranged sound-editing operators may comprise an operator which edits the amplitude of the source sound by a factor of any amount between 0.8 to 1.2. In this way, a single ranged sound-editing operator can be used in producing a variety sound effects to be output during video game gameplay based on a gameplay event. For example, if a video game character is nearby an explosion in the video game, the upper-amplitude (1.2 factor) end of the ranged sound-editing operator will be used. Such ranged operators could also comprise any of frequency ranges, temporal ranges and phase ranges.

Preferably, the plurality of candidate sound-editing operators are at least partly randomly generated. In this way, a large number of sound-editing operators may be generated quickly for use in producing the candidate sounds. The candidate sound-editing operators can be randomly generated by randomly selecting one or more parameters such a frequency selecting variable, an amplitude modulator, a frequency filter or a time period modulator and randomly varying properties of the selected parameters.

Alternatively, or additionally, the plurality of candidate sound-editing operators may be selected. In this way, a video game sound developer may be able to choose which sound-editing operators are likely to be most suitable for generating the desired candidate sound. The video game sound developer can then review and make changes to the selected sound-editing operators based on the previously generated set of candidate sounds. Once the suitable candidate sound has been generated, the selected sound-editing operators and the source sound can be stored.

Preferably, the plurality of candidate sound-editing operators are generated based on user-defined input parameters.

Preferably, the source sound comprises a sound sample or a white noise sound sample.

Preferably, the method comprises: iteratively generating a candidate sound-editing operator; and applying the generated sound-editing operator to a source sound or a previously generated candidate sound to produce a set of candidate sounds. In this way, a large quantity of candidate sounds can be generated to be analysed for their suitability of use in the video game. Candidate sounds in this manner are also more likely to be dissimilar from one other resulting in a variety of different candidate sounds.

Preferably, comparing each of the candidate sounds with known sounds in a library of known sounds comprises extracting features of each of the candidate sounds and comparing the extracted features to corresponding features of known sounds in a library of known sounds to determine the suitability of each of the candidate sounds. Preferably, the extracted features of each of the candidate sounds comprises spectral features and/or a volume envelope. Preferably, the suitability of each the candidate sounds is determined based on the similarity between the extracted features and corresponding features of the known sounds.

In this way, the comparison of the candidate sounds with the known sounds can be carried out more efficiently. This is advantageous if there are a large quantity of candidate sounds to be compared.

Preferably, the method further comprises: training a machine-learning model to learn a sound-editing operator for generating a required sound effect based on an input source sound; and storing the trained machine-learning model in the memory. Alternatively, or additionally, the learned sound-editing operator may be stored. The source sound and the required sound effect may be inputted into the trained machine learning model to output the required sound-editing operator. The required sound editing operator may then be stored for use during gameplay.

In a further aspect of the invention, there is provided a method for generating sound effects to be output during video game gameplay, the method comprising: obtaining a source sound; applying a plurality sound-editing operators to the source sound to generate a plurality of candidate sounds from the source sound; selecting a sound-editing operator based on the suitability of the associated candidate sound; and storing the source sound and the sound-editing operators used to generate the suitable candidate sound in a memory device for use in generating sound effects to be output during video game gameplay. This method may comprise aspects of the method for outputting a sound effect during video game gameplay described above.

Preferably, the plurality of candidate sound-editing operators are at least partially randomly generated. Preferably, the plurality of candidate sound-editing operators are generated based on user-defined input parameters.

Preferably, each candidate sound is compared to a known sound stored in a library to determine the suitability of each candidate sound and a sound editing operator is selected for storing based on the comparison.

Preferably, each candidate sound is output, the method further comprising: receiving a user input indicating a selection of a candidate sound; and storing the source sound and the sound-editing operator associated with the selected candidate sound in the memory for use in generating sound effects to be output during video game gameplay.

Preferably, the method further comprises: iteratively generating a candidate sound-editing operator; applying the generated sound-editing operator to a source sound or a previously generated candidate sound to produce a set of candidate sounds.

Preferably, comparing each of the candidate sounds with known sounds in a library of known sounds comprises extracting features of each of the candidate sounds and comparing the extracted features to corresponding features of known sounds in a library of known sounds to determine the suitability of each of the candidate sounds.

Preferably, the extracted features of each of the candidate sounds comprises spectral features and/or a volume envelope.

Preferably, the suitability of each the candidate sounds is determined based on the similarity between the extracted features and the corresponding features of the known sounds.

Preferably, the method further comprises training a machine-learning model to learn a sound-editing operator for generating a required sound effect based on an input source sound; and storing the trained machine-learning model in the memory. Alternatively, or additionally, the learned sound-editing operator may be stored. The source sound and the required sound effect may be inputted into the trained machine learning model to output the required sound-editing operator. The required sound editing operator may then be stored for use during gameplay.

In a further aspect of the invention, there is provided a computer program comprising instructions that, when executed by a computer, perform the methods described herein.

In a further aspect of the invention, there is provided a video game system, comprising: a processor configured to perform the methods described herein.

### BRIEF DESCRIPTION OF DRAWINGS

Embodiments of the invention are now described, by way of example, by reference to the drawings, in which:

FIG. 1A is a schematic diagram of an exemplary video game system in accordance with the invention;

FIG. 1B is a flow diagram of a computer-implemented method in an embodiment of the invention; and

FIG. 2 is a flow diagram of a computer-implemented method in another embodiment of the invention.

### DETAILED DESCRIPTION

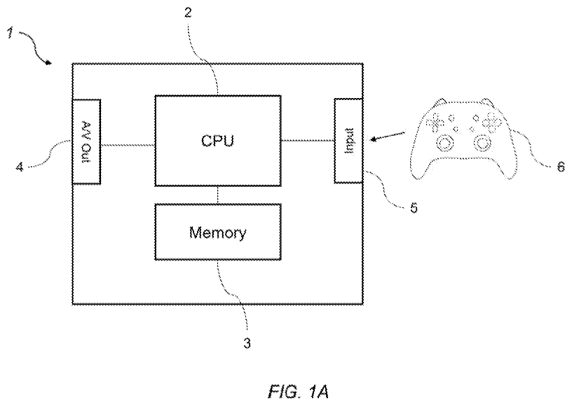

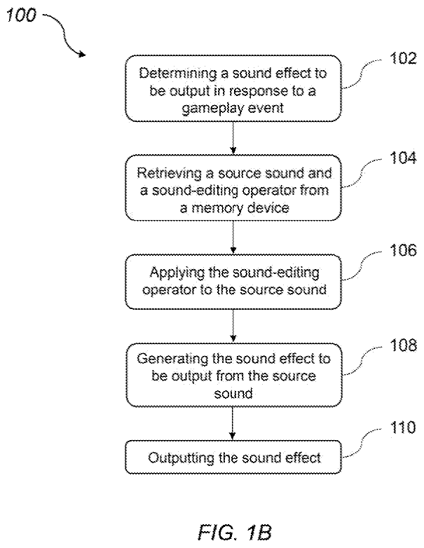

FIG. 1A is a schematic diagram of an exemplary video game system 1 in accordance with the invention. The video game system 1 is a video game console, for example. Alternatively, the video game system 1 may be a personal computer or a handheld personal computing device.

The system 1 comprises a central processing unit (CPU) 2, a memory device 3, an audio/visual output (A/V out) 4, an input 5 and a video game controller 6. The CPU 2 is in communication with the memory 3, the A/V out 4 and the input 5. The controller 6 is configured to provide user inputs to the input 5.

The CPU 2 is able to retrieve data from the memory device 3 and the input 5. The CPU processes the retrieved data and feeds the processed data, which can be audio data or video data, to the A/V Out 4. The CPU is configured to carry out the method 100 according to FIG. 1B.

The memory device 3 may comprise a random-access memory (RAM), a hard drive, or both a RAM and a hard drive. Audio and video data associated with video games are stored in the memory device 3. The A/V Out 4 of the system 1 feeds audio and video data from the system 1 to a device configured to output audio and video. From example, the A/V Out 4 may feed data to a television set or a monitor and a set of speakers that are coupled to the A/V Out 4 of the video game system 1.

The input 5 is configured to receive inputs from the video game controller 6. The input 5 may comprise an infrared sensor and the controller 6 may comprise an infrared emitter such that data can be transmitted to the video game console from the controller. The input 5 is configured to feed input data to the CPU 2. The CPU 2 can then determine how to process the audio and video data stored in the memory device 3 to output the audio and video data to the A/V out 4 during running of a video game.

FIG. 1B is a flow diagram of a computer-implemented method 100 for outputting a sound effect during video game gameplay in an embodiment of the invention. The method 100 comprises the steps 102, 104, 106, 108 and 110. The method 100 may be carried out by the CPU 2 of a video game system 1, as shown in FIG. 1A for example, during gameplay.

Step 102 comprises determining a sound effect to be output in response to a gameplay event. Step 104 comprises retrieving a source sound and a sound-editing operator from a memory device 3 and step 106 comprises applying the sound-editing operator to the source sound. Step 108 comprises generating the sound effect to be output from the source sound and step 110 comprises outputting the sound effect.

In the present embodiment, step 102 comprises determining a sound effect to be output in response to a gameplay event. The sound effect to be output corresponds to the gameplay event. For example, if a flash of lightning occurs in the video game environment during gameplay as programmed, the sound effect to be output would be a clap of thunder.

In alternative embodiments, the gameplay event may be in response to a user input received at the video game system 1 from a video game controller 6. In this case, the sound effect to be output corresponds to a gameplay event that is caused by the user input. For example, if the user were to press a trigger button on the video game controller 6, causing a virtual gun to fire in the video game environment, the sound effect to be output would be the sound of the virtual gun firing.

At step 104, a source sound and a sound-editing operator are both retrieved from a memory device 3. The memory device 3 is a memory device within a video game system 1. The source sound and the sound-editing operator are both retrieved from a memory device 3 of the system 1 by the central processing unit (CPU) 2 within the system 1. The CPU 2 is then able to perform operations on the source sound using the sound-editing-operator. The source sound is an audio file, and the sound-editing operator is an algorithm configured to edit data in audio files.

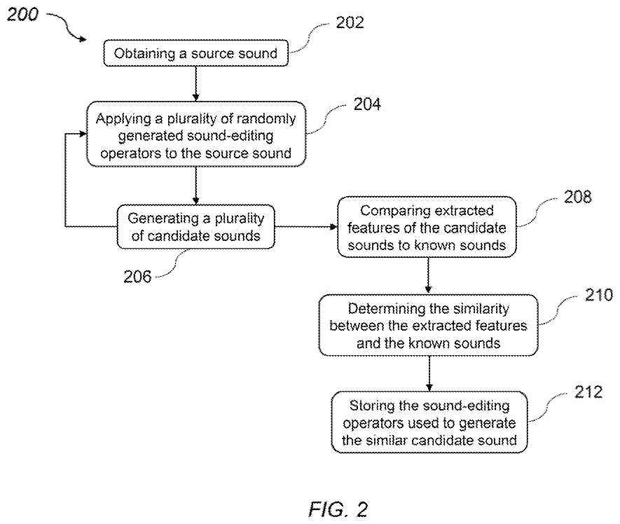

In embodiments of the invention, the sound editing operator us to produce the sound effect to be output is determined by the method 200 according to FIG. 2. The method 200 according to FIG. 2 may be incorporated into the method 100 according to FIG. 1B. Alternatively, the method 200 according to FIG. 2 may be carried out during the development and design of a video game.

In the embodiment according to FIG. 1B, only a single audio file associated with the source sound is stored in a memory device 3 of the video game system 1. In alternative embodiments, a plurality of different audio files associated with different source sounds may be stored in a memory device 3 of the system 1.

Step 106 comprises applying the sound-editing operator to the source sound. In the present embodiment, the CPU 2 of the video game system 1 applies the sound-editing operator to the audio file of the source sound, wherein the audio file of the source sound and the sound-editing operator are each retrieved from a memory device 3 of the system by the CPU at step 104.

In the present embodiment, step 108 comprises generating the sound effect to be output from the source sound. The sound effect is generated from the source sound by the application of the sound-editing operator algorithm to the audio file of the source sound by the CPU 2, thereby producing a new audio file corresponding to the sound effect. In this embodiment, the sound-editing operator is an algorithm that edits data in the audio file associated with the source sound.

In various embodiments, the sound-editing operator may comprise one or more of an edit of an amplitude or amplitude range of the source sound; an edit of a frequency or frequency range of the source sound; or an edit of temporal or phase characteristics of the source sound. The application of sound editing-operator to the audio file of the source sound can therefore greatly alter the properties of the source sound to produce the sound effect to be output.

In the present embodiment, the sound effect is output at step 110. The sound effect is output by an audio output 4 of the video game system 1. This occurs at substantially the same time as the visual output corresponding to the gameplay event, from which the sound effect is determined in response to.

FIG. 2 is a flow diagram of a computer-implemented method 200 for generating sound effects to be output during video game gameplay in another embodiment of the invention. The method 200 comprises the steps 202, 204, 206, 208, 210 and 212. In embodiments of the invention, the method 200 according to FIG. 2 may be incorporated into the method 100 according to FIG. 1B. In alternative embodiments of the invention, the method 200 according to FIG. 2 may be carried out as a standalone process as part of the design and development of a video game, for example.

Step 202 comprises obtaining a source sound and step 204 comprises applying a plurality of randomly generated sound-editing operators to the source sound. Step 206 comprises generating a plurality of candidate sounds and step 208 comprises comparing extracted features of the candidate sounds to known sounds. Step 210 comprises determining the similarity between the extracted features and the known sounds and step 212 comprises storing the sound-editing operator used to generate the similar candidate sound.

In the present embodiment, step 202 comprises obtaining a source sound. The source sound is an audio file and is obtained from a library of known sounds. The source sound may be, for example, an audio file corresponding to the sound of a pig oinking. In alternative embodiments, the source sound may comprise a multiple of different audio files corresponding to a multiple of different sounds or the source sound may comprise a white noise audio file.

In the present embodiment, step 204 comprises applying a plurality of randomly generated sound-editing operators to the source sound. The sound-editing operators in this embodiment are algorithms which comprise many different parameters that may be randomly varied. The sound-editing operators edit data in the audio file corresponding to the source sound to produce new audio files. For example, the sound-editing operators may comprise one or more of an edit of an amplitude or amplitude range of the source sound; an edit of a frequency or frequency range of the source sound; or an edit of the duration of the source sound. These edits may vary between each randomly generated sound-editing operator.

In the present embodiment, step 206 comprises generating a plurality of candidate sounds. The plurality of candidate sounds are new audio files generated from the source sound as a result of the application of the plurality of randomly generated sound-editing operators to the source sound. As the randomly generated sound-editing operators differ from each other, a variety of different, or random, candidate sounds are produced.

In various embodiments, the plurality of randomly generated sound-editing operators may be iteratively applied to the generated candidate sounds to produce a greater number of candidate sounds in a set. This optional step is demonstrated by the arrow returning to step 204 from step 206 in FIG. 2. Alternatively, the plurality of randomly generated sound-editing operators may be iteratively applied to the same source sound to produce a greater number of candidate sounds in a set.

Alternatively, or additionally, the method may comprise applying a plurality of selected sound-editing operators to the source sound. For example, the method may produce five candidate sounds from randomly generated sound-editing operators. The method may iterate through a large set of random/pre-determined sound-editing operators to find more suitable sound-editing operators. This may be based on the sound-editing operators used to generate the five candidate sounds effects, or randomly, or based on acoustic variations between the five candidate sounds (amplitude, high freq. roll off, addition of some randomised noise). The program may output each more suitable sound-editing operator to a video game sound developer one at a time and they could accept/reject each of the more suitable sound-editing operators. Once a certain number of more suitable sound-editing operators have been selected, the source sound and the selected sound-editing operators can be stored.

In the present embodiment, step 208 comprises comparing extracted features of the candidate sounds to known sounds. The known sounds are stored in an online library, for example. Each of the audio files corresponding to the generated candidate sounds are analysed and features of each of the audio files corresponding to the generated candidate sounds are extracted. The extracted features are then compared with corresponding features of the known sounds. The extracted features are portions of data taken from the audio files corresponding to the candidate sounds.

In this embodiment, the features extracted from the candidate sounds comprise data associated with spectral features and/or a volume envelope. Data associated with the spectral features and/or the volume envelope of each of the candidate sounds are compared with data associated with the spectral features and/or the volume envelope of the known sounds. In alternative embodiments, other data corresponding to other features of the candidate sounds may be extracted and used in the comparison.

At step 210, the similarity between the extracted features and the known sounds is determined. This step is carried out to determine the suitability of each of the candidate sounds for use as a video game sound effect. Data associated with the extracted features, in this case the spectral features and/or the volume envelope of each of the candidate sounds, are compared with data associated with the spectral features and/or the volume envelope of the known sounds and the degree of similarity between the respective data is calculated. As the candidate sounds are randomly generated, some of the sounds will be more similar to the known sounds than others. The candidate sounds that are dissimilar to the known sounds are unlikely to be useful for use as a video game sound effect.

At step 212, the sound-editing operators used to generate the similar candidate sounds are stored. Based on the comparison and the determined similarity between the extracted features of the candidate sounds and the corresponding features of the known sounds, the sound-editing operators used to generate the most similar candidate sounds are stored for use in producing sound effects during video game gameplay. Only the source sound and the required sound-editing operators have to be stored in a memory device of a video game system, therefore.

In embodiments of the invention, storing the source sound and the associated sound-editing operator in the memory may comprise storing the source sound and a ranged sound-editing operator. In particular, the sound-editing operator may comprise a variable component that is selected at runtime. For example, it may comprise some edit instructions in full and others that comprise a variable parameter that is selected between a particular predefined range at run time. Such ranged sound-editing operators may comprise an operator which edits the amplitude of the source sound by a factor of any amount between 0.8 to 1.2. In further embodiments, ranged sound-editing operators could also comprise any of frequency ranges, temporal ranges and phase ranges.

The method 200 of the embodiment according to FIG. 2 may optionally further comprise the steps of training a machine-learning model to apply the sound-editing operators to the source sound to generate sound effects that are similar to the known sounds; and storing the trained machine-learning model in the memory system.

1. A computer-implemented method for outputting a sound effect during video game gameplay, the method comprising:
determining a sound effect to be output;
retrieving a source sound and a sound-editing operator from a memory, wherein the sound-editing operator comprises edit instructions that, when applied to the source sound, generate the sound effect to be output;
applying the sound-editing operator to the source sound to generate the sound effect to be output; and
outputting the sound effect.

2. The computer-implemented method according to claim 1, wherein the sound effect to be output is determined in response to a gameplay event in the video game.

3. The computer-implemented method according to claim 1, wherein the sound-editing operator comprises instructions to perform an edit of a parameter of the source sound.

4. The computer-implemented method according to claim 3, wherein the parameter comprises one or more of: an amplitude or amplitude range of the source sound; a frequency or frequency range of the source sound; temporal characteristics of the source sound; or phase characteristics of the source sound.

5. The computer-implemented method according to claim 1, wherein the sound editing operator comprises a variable edit parameter for editing a parameter of the source sound by a variable magnitude within a predetermined range, wherein the variable magnitude is selected at runtime during gameplay.

6. The computer-implemented method according to claim 1, further comprising:
determining a plurality of sound effects to be output;
retrieving a source sound and a plurality sound-editing operators from a memory, each sound-editing operator comprising edit instructions that, when applied to the source sound, generate a different sound effect to be output;
applying each sound-editing operator to the source sound to generate the plurality of sound effects to be output; and
outputting the plurality of sound effects.

7. The computer-implemented method according to claim 1, wherein the sound-editing operator is determined by:
applying a plurality of candidate sound-editing operators to the source sound to generate a plurality of candidate sounds from the source sound;
comparing each of the candidate sounds with known sounds in a library of known sounds to determine the suitability of each of the candidate sounds for use in the video game; and
based on the comparison, selecting one of the candidate sounds; and
storing the source sound and the sound-editing operator associated with the selected candidate sound in the memory for use in generating sound effects to be output during video game gameplay.

8. The computer-implemented method according to claim 7, wherein the plurality of candidate sound-editing operators are at least partly randomly generated or generated based on user-defined input parameters.

9. The computer-implemented method according to claim 7, further comprising:
iteratively generating a candidate sound-editing operator; and
applying the iteratively generated sound-editing operator to the source sound or a previously generated candidate sound to produce the plurality of candidate sounds.

10. The computer-implemented method according to claim 7, wherein comparing each of the candidate sounds with known sounds in a library of known sounds comprises extracting features of each of the candidate sounds and comparing the extracted features to corresponding features of known sounds in a library of known sounds to determine a suitability of each of the candidate sounds.

11. The computer-implemented method according to claim 10, wherein the extracted features of each of the candidate sounds comprises at least one of spectral features or a volume envelope.

12. The computer-implemented method according to claim 10, wherein the suitability of each the candidate sounds is determined based on a similarity between the extracted features and the corresponding features of the known sounds.

13. The computer-implemented method according to claim 1, wherein the sound-editing operator is determined by:
applying a plurality of candidate sound-editing operators to the source sound to generate a plurality of candidate sounds from the source sound;
outputting the candidate sounds;
receiving a user input selecting a candidate sound; and
storing the source sound and the sound-editing operator associated with the selected candidate sound in the memory for use in generating sound effects to be output during video game gameplay.

14. The computer-implemented method according to claim 1, wherein the source sound comprises a sound sample or a white noise sound sample.

15. A video game system comprising a processor configured to perform the method of claim 1.

16. A computer-implemented method for generating sound effects to be output during video game gameplay, the method comprising:
obtaining a source sound;
applying a plurality of sound-editing operators to the source sound to generate a plurality of candidate sounds from the source sound;
selecting a sound-editing operator based on a suitability of the associated candidate sound; and
storing the source sound and the sound-editing operator used to generate the suitable candidate sound in a memory device for use in generating sound effects to be output during video game gameplay.

17. The computer-implemented method according to claim 16, wherein the plurality of candidate sound-editing operators are at least partially randomly generated or generated based on user-defined input parameters.

18. The computer-implemented method according to claim 16, further comprising:
comparing each of the candidate sounds with known sounds stored in a library to determine the suitability of each of the candidate sounds; and
selecting the sound editing operator storing based on the comparison.

19. The computer-implemented method according to claim 16, further comprising:
outputting each candidate sound;
receiving a user input indicating a selection of a candidate sound; and
storing the source sound and the sound-editing operator associated with the selected candidate sound in the memory for use in generating sound effects to be output during video game gameplay.

20. The computer-implemented method according to claim 16, further comprising:
iteratively generating a candidate sound-editing operator; and
applying the iteratively generated sound-editing operator to a source sound or a previously generated candidate sound to produce a set of candidate sounds.

21. The computer-implemented method according to claim 16, wherein selecting a sound-editing operator based on the suitability of the associated candidate sound further comprises:
extracting features of each of the candidate sounds; and
comparing the extracted features to corresponding features of known sounds in a library of known sounds to determine the suitability of each of the candidate sounds;
wherein the suitability of each the candidate sounds is determined based on the similarity between the extracted features and the corresponding features of the known sounds.

22. A computer program comprising instructions that, when executed by a computer, perform the method of claim 16.
